(19) United States
(12) Patent Application Publication
(10) Pub. No.: US 2013/0254311 A1
(43) Pub. Date: Sep. 26, 2013

(54) METHOD AND SYSTEM FOR CONTROL OF THE COLLECTION OF EMAIL MESSAGES

(71) Applicant: YANDEX EUROPE AG, Luzern (CH)

(72) Inventors: Egor Vladimirovich GANIN, Shishkin Forest (RU); Alexei Vladimirovich KAPRANOV, Bryansk (RU)

(73) Assignee: YANDEX EUROPE AG, Luzern (CH)

(21) Appl. No.: 13/849,570

(22) Filed: Mar. 25, 2013

(30) Foreign Application Priority Data
Mar. 23, 2012 (RU) 2012111128

(51) Int. Cl. H04L 12/58

(52) U.S. Cl. CPC H04L 51/22
USPC 709/206

(57) ABSTRACT

Email message collector system with ability to control the mail collection for both registered users of the mail system and for new users, containing interconnected internal and external interface means for control of the message collection, and a collection module for dividing up the tasks of message collection and control of the collection processor, providing for a periodic checking of specified source mail boxes and, if messages are present in them, their forwarding to a common recipient box, while the external interface is designed to designate a source box, register the recipient box if necessary, and launch the collection, being accessible both to users authorized on the recipient server and unauthorized users, and the internal interface makes possible the adding of a source box and launching of the message collection, being part of the interface of the recipient box mail system and accessible to users authorized on the recipient server.

### CROSS-REFERENCE

The present application claims priority to Russian Patent Application No. 2012111128, filed Mar. 23, 2012, entitled “ [symbol] [symbol] [symbol] [symbol] [symbol] [symbol] [symbol] ” (“Method and System for Control of the Collection of Email Messages”), the entirety of which is incorporated herein by reference.

### FIELD OF THE INVENTION

The present invention refers to the field of electronic transmission and processing of information, specifically, the functions of email.

### BACKGROUND

The following terminology is used for convenience of explaining the invention:
“Messages”—email messages.
“Mail systems”—email systems.
“Source server”—the mail server from which email messages are dispatched.
“Recipient server”—the mail server to which the email messages are dispatched.
“Mail box”—repository of email messages.
“Source box”—the email box from which email messages are dispatched.
“Recipient box”—the email box to which email messages are dispatched.
“Mail box name”—the user's email address, for example, login@mailbox.ru.
The semantic content of these definitions corresponds to the generally received terminology.

The use of various telecommunications resources in the modern world is becoming ever more popular. One of these resources is email.

Email can be used for business correspondence, exchanging messages of a personal nature, sending and receiving deliveries. A typical situation is when the user has several mail boxes (email addresses) for different purposes. For example, a common case is the division between business and personal correspondence, where one mail box is used to send and receive business messages and another one for personal messages. Besides this, the user can also have mail boxes for other purposes, such as receiving announcements and advertising information from organizations etc.

A mail collection function is usually provided to work with several mail boxes in existing mail systems. This function allows for automatic forwarding of messages from various mail boxes to one recipient mail box. Thus, the user is able to process all messages in a single mail box, using for this the interface of the recipient box mail system.

A mail collector is provided by various IT companies, such as on the GMX.com and Mail.com sites:
http://help.gmx.com/mail/settings/mail/mc/
http://www.mail.com/mail/mail-collector

Patented technical solutions involving the handling of email are also known.

The invention of RF patent No. 2400810 pertains to network systems and, in particular, the definition, creation or supporting of links between users of network systems. The invention provides a more effective system for rapid creation of new links and support of existing links between users (such as mail boxes) of a network system. It is proposed to perform a search for connections of each user in a database by a unique user identifier, specified by the user.

The invention of RF patent No. 2363981 pertains to communications systems and methods. The technical result is to ensure transmission of email between many users who are its senders or receivers or both. The system and the method use the Internet and supplement it with a mail server with mail software linked to the Internet. The sender uses the mail software of the sender to select a mail transmission by using “ePostal Service”. The system and the method can be used in networks serving many terminals. Additional services include identification of sender and confirmation of his access rights, filtering of mail for technical dangers and information content dangers, encryption, confirmation of receipt and opening of mail, the post office “window” function, and mail storage functions.

The invention of RF patent No. 2302033 pertains to communications engineering and can be used in systems capable of providing continuity between message exchange clients. The technical result consists in providing continuity between message exchange clients. The message exchange communication system includes a plurality of message exchange clients. The first message exchange client establishes the first communication link, working with the use of a client data set. The first message exchange client sends the client data set to a second message exchange client. The second message exchange client establishes a second communication link, working with the use of the client data set.

The invention of RF patent No. 2413380 pertains to a communication system which sends/receives email between a sending device and receiving device via a network. The technical result consists in affording the possibility of adaptively selecting a route of transmission/reception of the confirmation of transmission of the email. The transmission device transmits the email to the reception device via the network, selecting one of a communication method through the mail server or a communication method without the intervention of the mail server. This transmission device formats the email and transmits to the reception device the email and information providing a method of response to the request for confirmation of the transmission, in response to the email. The transmission device receives from the reception device in accordance with the method of reply the result of the confirmation of the transmission in response to the email sent.

Application WO 99/17505 describes a system of forwarding mail in a private network, whose makeup includes a server, a stationary computer and a router for connection to a common-use network that is external to the private network, all these being interconnected by means of a data exchange channel. The server controls the email resources that have arrived in the private network and are addressed to the user of the stationary computer. The mail forwarding system has a mail forwarding program which is run on the stationary computer and controls the operation of the stationary computer for selective (a) extraction from the private network of email resources addressed to the user of the stationary computer, and (b) transmission of the extracted email resources via the router according to the indicated address in the common-use network.

In the capacity of known analogues, one can also cite the following U.S. Pat. Nos. 8,078,681, 8,045,698, 7,984,297, 7,966,372, 7,917,394, 7,849,140, 7,613,776, 7,519,675, 7,375,614, 7,042,335, 6,981,020, 6,477,703, and PCT applications: WO2008/057528, WO2005/082101, WO2004/008348, in which email variants are described with message handling and arrangement according to user-specified conditions.

As already noted above, the practical realization of a mail collector system is known in the GMX products or on the Mail.com site, which can be chosen as prototypes.

The known mail collectors make it easier to work with several mail boxes, but along with the benefits there are a number of complications.

First and foremost, the mail collection function is available only to authorized users of the mail system in the interface of the recipient box mail system. To obtain access to the collection functions, the user must register the recipient box, become authorized in it, and only then set up the required collection parameters in its interface. Furthermore, one cannot change the name of the recipient box—this requires exiting the recipient box interface, registering a new box, and performing the setup in its interface.

The procedure of setting up the mail collector is itself rather complicated, often requiring a specification of technical parameters needed for optimal collection operation (such as the host and port number of the source server). Moreover, the set of parameters is specific to each mail system.

Thus, the registering of each source box can be complicated and take up a lot of time. If it is necessary to collect messages from several source boxes, the length of the setup can increase many times over.

Finally, messages obtained from different source boxes are displayed in the mail system interface by a single list, which can be awkward for a visual review and searching for a needed message.

These drawbacks limit the use of the mail collector, making it less effective and, in the final analysis, decreasing the popularity of the mail system as a whole.

On the contrary, optimal functionality of a mail collector with simple and convenient interface can substantially ease the work of the user with several mail boxes, encouraging an increase in the number of users of the mail system. Thus, there is a real need for a solution to the problem of solving the indicated problems and a rapid setup of a message collector from specified mail boxes in a single recipient box, and if there is no such box the option of registering a recipient box directly in the process of setup of the mail collection.

One of the aspects of the present invention is the implementing of a system and a method for control of message collection, in which the mail collection functionality is available to both authorized and unauthorized users of the mail system. This possibility is realized by dividing up the collection control functions between two interfaces: an external and an internal one.

Yet another aspect of the present invention is the possibility of controlling the collection by means of an external interface, being a set of screen forms containing elements for:
entry and saving of the name of the source box and the password for access to it;
entry and saving of the registration parameters of the recipient box;
launching the message collection.

Yet another aspect of the present invention is the possibility of controlling the collection by means of an internal interface, being a set of screen forms containing elements for:
displaying a list of source boxes;
entry and saving of the name of the source box and the password for access to it;
launching the message collection;
controlling the display of messages in the mail system interface of the recipient box, wherein the set of messages from each source box is put out as a separate list.

Yet another aspect of the present invention is to provide an interface for collection of messages to users not authorized on the recipient server and not even having a recipient box. This option is realized by the external interface of the Collector, in which a separate form of registration of a mail box is provided. The option of controlling the Collector by authorized users using both the external and the internal interface is preserved.

Yet another aspect of the present invention is an adaptive setup of the collection, consisting in the following:
providing an external interface depending on user authorization. This is accomplished by automatic checking of the fact of authorization of the user who has launched the external interface of the Collector. Unauthorized users are asked to fill out several screen forms. For an authorized user, the setup consists in specifying data for access to the source box in a single screen form.
automatic definition and initiation of specific collection parameters (such as the host and port number of the source server, the frequency of checking, the location for messages being forwarded, the need to use filters, etc.).
the option of selecting the name of the recipient box in the Collector interface. The name of the recipient box is formed automatically on the basis of data about the name of the source box, or it is specified by the user manually. This function is accessible to users who are not authorized on the recipient server, in the external interface.

A further problem of the present invention is to develop a system and method of control of message collection in which the mail collection functionality is accessible to both authorized and unauthorized users of the mail system.

Yet another problem of the present invention is to develop an external interface for control of mail collection containing screen forms with a set of elements for:
entry and saving of the name of the source box and the password for access to it;
entry and saving of the registration parameters of the recipient box;
launching the message collection.

Yet another problem of the present invention is to develop an internal interface to control the mail collection, containing screen forms with a set of elements for:
displaying a list of source boxes;
entry and saving of the name of the source box and the password for access to it;
launching the message collection;
controlling the display of messages in the mail system interface of the recipient box mail system, wherein the set of messages from each source box is put out as a separate list.

Yet another problem of the present invention is to develop a method of control of message collection by users who have no mail box for message collection.

Yet another problem of the present invention is to simplify the procedure for setup of mail collection by an adaptive interface which automatically determines the fact of authorization of the user, as well as the message collection parameters, including the name of the recipient box. There is therefore a need for a

### SUMMARY

It is an object of the present invention to ameliorate at least some of the inconveniences present in the prior art.

In one aspect, embodiments of the present invention provide a . . .

The present invention is proposed to solve these problems.

The claims characterize the email message collector system with ability to control the mail collection for both registered users of the mail system and for new users, containing interconnected internal and external interface means for control of the message collection, as well as a collection module for dividing up the tasks of message collection and control of the collection processor, providing for a periodic checking of specified source mail boxes and, if messages are present in them, their forwarding to a common recipient box, while the external interface is designed to designate a source box, register the recipient box if necessary, and launch the collection, being accessible both to users authorized on the recipient server and unauthorized users, and the internal interface makes possible the adding of a source box and the launching of the message collection, being part of the interface of the recipient box mail system and is accessible to users authorized on the recipient server.

The collector system implements a collection control external interface, containing screen forms with a set of elements for entry and saving of the name of the source box and the password for access to it, entry and saving of the registration parameters of the recipient box, and launching of the message collection.

The collector system also implements a collection control internal interface, containing screen forms with a set of elements for displaying a list of source boxes, entry and saving of the name of the source box and the password for access to it, launching the message collection, and controlling the display of messages in the mail system interface of the recipient box mail system, wherein the set of messages from each source box is put out as a separate list.

In addition, the collector system implements a verification of the fact of authorization of the user on the source server in order to provide said user of the external interface with a corresponding set of screen forms.

In addition, in the external interface of the collector system there is implemented a recipient mail box registration form to provide access to the collection functionality to users who are not authorized on the recipient server and do not have a mail box for message collection, with possibility of automatic creation of a box name or manual designation of a name.

The collection module of the collector system implements the option of automatic saving or deletion of messages in the source box after their forwarding to the recipient box.

A method of control of email message collection is also proposed that is accessible to both registered users of the mail system and to new users, wherein:
the functions of control of message collection are divided up between two interfaces: external and internal, wherein access to the external interface is offered to authorized and unauthorized users, including users not having a recipient box, and access to the internal interface is offered to users who are authorized on the recipient server, it being possible for users not having a recipient box to register for one;
the fact of authorization of the user, the name of the recipient box, and specified message collection parameters from other boxes are recorded, with option of reviewing the email messages.

The proposed email collector system contains internal and external interface means for control of message collection, and also a collection module by which a periodic checking is done for the specified source mail boxes and, if messages are present in them, the latter are forwarded to a common recipient box.

The collection control external interface contains screen forms with a set of elements for entry and saving of the name of the source box and the password for access to it, entry and saving of the registration parameters of the recipient box, and launching of the message collection. The realization of the external interface and its display are accomplished on the screens of modern computer monitors.

The collection control internal interface contains screen forms with a set of elements for displaying a list of source boxes, entry and saving of the name of the source box and the password for access to it, launching the message collection, and controlling the display of messages in the mail system interface of the recipient box mail system, wherein the set of messages from each source box is put out as a separate list. The realization of the internal interface is available by use of modern software.

The system implements a verification of the fact of authorization of the user on the recipient server in order to provide said user of the external interface with a corresponding set of screen forms.

In the external interface of the system there can be implemented a recipient mail box registration form to provide access to the collection functionality to users who are not authorized on the recipient server and do not have a mail box for message collection, with possibility of automatic creation of a box name or manual designation of a name.

The collection module implements the option of automatic saving or deletion of messages in the source box after their forwarding to the recipient box.

A method of control of email message collection is also proposed that is accessible to both registered users of the mail system and to new users, wherein:
the functions of control of message collection are divided up between two interfaces: external and internal, wherein access to the external interface is offered to authorized and unauthorized users, including users not having a recipient box, and access to the internal interface is offered to users who are authorized on the recipient server, it being possible for users not having a recipient box to register for one;
the fact of authorization of the user, the name of the recipient box, and specified message collection parameters from other boxes are recorded, with option of reviewing the email messages.

The present invention of a mail collector (“Collector”) is a software/hardware complex, making it possible to control the collection of email messages from specified email boxes. By “collection” is meant the forwarding of messages from one or more mail boxes to a single mail box.

The mail box from which the message is forwarded is called hereinafter the source box, and the mail box to which messages are forwarded is the recipient box.

The source boxes reside on the server of the mail system, which is called hereinafter the source server, while the recipient box resides on the recipient server. In the general case, these servers are used by different mail systems, but they can belong to the same mail system.

Embodiments of the present invention each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects and advantages of embodiments of the present invention will become apparent from the following description, the accompanying drawings and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 shows the general diagram of the Collector, showing its functional makeup and illustrating the interaction of the Collector with the components of the mail infrastructure according to the present invention.

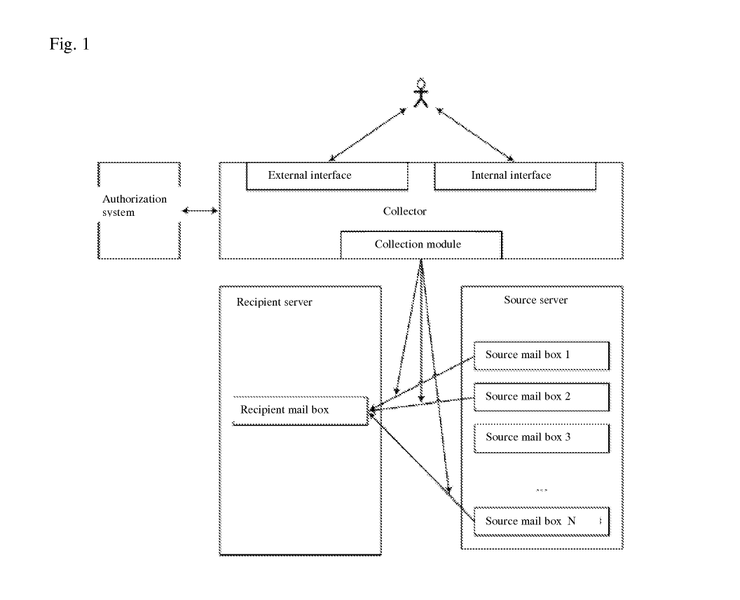

FIG. 2 shows the algorithm for the working of the collection module.

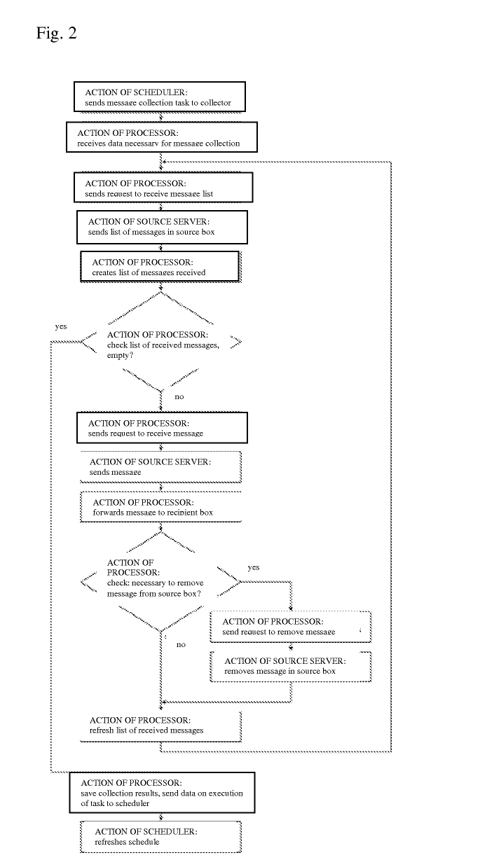

FIG. 3 shows the algorithm for control of the Collector by means of the external interface according to the present invention.

FIG. 4 shows the diagram of jumps between screen forms of the external interface of the Collector according to the present invention.

FIG. 5 shows the algorithm for control of the Collector by means of the internal interface according to the present invention.

### DETAILED DESCRIPTION

The principal components of the Collector are the message collection module, the internal and external interfaces. The database of the Collector is also used as a repository of information that can be implemented on the mail server.

The collection module is the principal component of the Collector, providing for the forwarding of messages from the source box to the recipient box. The collection module is a hardware/software complex, which can be installed on a dedicated server or on the recipient server. The collection module includes two interconnected components: the scheduler and the collection processor.

The scheduler is software that enables an allocation of the message collection tasks and control of the collection processor.

Allocation of the collection tasks is done by means of a schedule. The schedule contains a list of message collection tasks and defines the order of their accomplishment. The order of accomplishment of the tasks is determined by the scheduler, based on available information as to the frequency of checking the source boxes. This parameter is specified by the users when setting up the collection or it is determined by default. In drawing up the schedule, allowance is also made for the fact that the number of simultaneously executed tasks should not exceed the maximum allowed. Once formed, the schedule is kept in the database of the Collector.

Each task defines the parameters for forwarding messages from a defined source box to a defined recipient box. The parameters are designated by the user when setting up the collection or are automatically designated by the Collector. The set of parameters for each of the tasks is kept in the database of the Collector.

The execution of the collection task is initiated by the scheduler. At a moment defined by the schedule, the scheduler relays the task to the collection processor.

The collection processor can be software which processes the message collection tasks. Having received the task from the scheduler, the collection processor determines the necessary parameters: the name of the source box and the recipient box, the passwords for access to them, the host and port number of the source server, etc. These parameters are read by the collection processor from the database of the Collector.

The collection of messages is done by the processor using the POP3 protocol, similar to existing mail systems.

The collection procedure is performed in the following sequence.

Having received a task from the scheduler and having determined the collection parameters on the basis of the data contained in it, the collection processor checks for the presence of messages in the source box. For this, a query is sent to the port of the source server, containing the name of the source box. In the reply to the query, the source server transmits a list of letters present in the source box.

On the basis of the received data, the collection processor creates a list of messages that need to be received from the source server. In creating the list, it considers whether it is necessary to receive messages that were in the source box at the time that the user launched the Collector, and exclude messages that there obtained previously. This information is relayed to the collection processor in the task parameters.

If the list created contains at least one item, the collection processor requests the message at the source server. The source server relays the message from the source box to the collection processor, which in turn forwards the letter to the recipient box. The original message may be kept in the source box or removed after forwarding—this parameter is established by the user in the setup phase of the Collector and preserved in the task parameters after its launching. If it is necessary to remove the message, the processor sends a request to the source server which, in turn, removes the message in the source box.

After forwarding each message, the collection processor refreshes the list of messages received. The list is necessary, for example, in the event that only some of the messages were received, after which the source server became unavailable for whatever reason. When refreshing the access to the source server, the collection processor determines which messages were already received to prevent their repeated forwarding from the source server.

Moreover, during setup of the Collector the user can specify the need for a collection of only new messages. In this case, after the launching of the Collector by the user, all messages which the source box contained at the moment of launching of the Collector will be kept in this list. This will prevent their being forwarded from the source server.

The collection procedure is then repeated: the processor receives a list of messages from the source server, compares this with the refreshed list of messages already received and on the basis of this information creates a new list of messages to be received. The collection procedure is repeated until the list of messages to be received contains at least one item. In this case, the collection processor saves the task execution results and relays them to the scheduler, which refreshes the schedule.

In the context of a single task, mail is collected from one source box for one specific recipient box. If when setting up the collection the user specified several source boxes, the scheduler includes mail for each of them in the schedule of the collection task. Each of the tasks is executed similar to the algorithm described.

The collection module runs automatically in the background, that is, transparent to the user and without his involvement.

The functionality of the Collector is similar to the known mail collection solutions: http://help.gmx.com/mail/settings/mail/mc/ and http://www.mail.com/mail/mail-collector.

One of the differences in the proposed Collector from the indicated solutions is the possibility of control of the mail collection for both registered and unregistered users of the mail system. This option is not available in the known solutions, the message collection interface is not provided to unregistered users of the mail system.

The interface provided by the Collector is adaptive: the set of screen forms and their external appearance depends on the fact of the user's authorization and the possibility of automatic definition of the collection parameters.

Another difference of the proposed Collector from known solutions is the possibility of putting out the messages received from each source box as a separate list. Access in the interface of the mail system of the recipient box is provided by the realization of additional control elements—references or buttons. In the analogous solutions, this function is not available. Furthermore, it is possible to change the name of the recipient box when setting up the mail collection. The function is not available in the analogous solutions, since the setup of the collection is done inside the interface of the mail system of the recipient box. The proposed Collector realizes its own interface, offering this possibility.

The external interface of the Collector is designed to specify the source box, to register the recipient box if necessary, and to launch the collection. This interface is available both to users authorized on the recipient server and to unauthorized users. The external interface is realized in the form of a set of screen forms provided outside the interface of the mail system of the recipient box.

The screen forms of the external interface contain a set of elements providing:
entry and saving of the name of the source box and the password for access to it;
entry and saving of the registration parameters of the recipient box;
launching the message collection.

The working of the external interface depends on whether the user is authorized on the recipient server. An authorized user is presented with a single screen form in which it is necessary to specify the name of the source box and the password for access to it, after which the collection is launched. An unauthorized user is asked to fill out three screen forms in succession: on the first, enter the name of the source box; on the second, select the name of the recipient box and register it; on the third, enter the password for access to the source box; after which the user can launch the message collection.

The internal interface makes it possible to add a source box and launch the message collection, being part of the interface of the mail system of the recipient box and accessible to users authorized on the recipient server.

The internal interface contains screen forms providing:
displaying of a list of source boxes;
entry and saving of the name of the source box and the password for access to it;
launching the message collection.

Furthermore, the internal interface provides elements for control of the output of messages in the interface of the mail system of the recipient box. These elements make it possible to display messages from each source box as a separate list.

The authorization system saves the authorization data, and also data on the relations between the recipient boxes and the source boxes.

The authorization data are used by the Collector for access to the mail boxes. The data on the relations between the recipient boxes and the source boxes are queried by the collection module in the process of the message collection.

General algorithm for the operation of the Collector

Using the internal or external web interface, the user specifies one or more source boxes and, if necessary, registers a recipient box, the other collection parameters being defined automatically.

For the automatic definition of the collection parameters, a list of servers of the mail systems is kept in the Collector. The list contains data necessary for access to the mail servers and collection of mail from them: domain, server name, port number, etc. The data are kept in a current state by periodic refreshing.

After the user specifies the name of the source box, the Collector determines the domain to which the box belongs and initializes the collection parameters, using domain data from the list. If it was not possible to initialize the parameters automatically, the user can specify them manually in the internal or external web interface of the Collector.

If it is necessary to collect mail from several source boxes, the user registers each of them consecutively in the Collector, using the internal or external interface. For each source box, the Collector automatically determines the collection parameters, using available information on the servers of the mail systems.

Upon completing the setup, the collection procedure is launched, in the course of which the Collector periodically polls each source box and, if messages are present in them, forwards them to the recipient box. Depending on the settings, the initial messages may be saved on the source server (message copying) or removed (message transfer). The Collector runs in the copying mode by default, leaving the original messages on the source server. The user can review the received messages in the interface of the mail system of the recipient box.

As already noted above, the Collector contains the following principal components: external interface, internal interface, collection module.

The external interface is a set of web forms and is accessible at a particular address that the user must enter on the address line of the browser. The number of web forms depends on the user authorization on the recipient server.

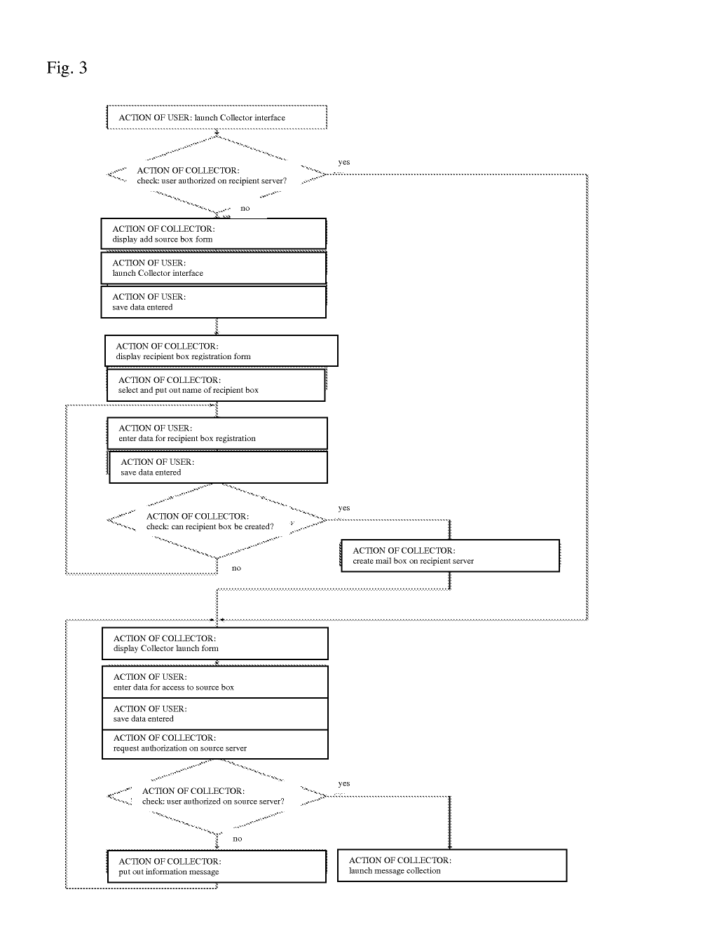

The algorithm for control of the Collector by means of the external interface is shown in FIG. 3.

Upon launching of the external interface, the Collector checks whether the user is authorized on the recipient server. If the user is unauthorized, the screen form for adding a source box is displayed; otherwise, the Collector launch form.

The form for adding a source box is designed to specify the name of a source box. The name of the source box entered on this form is used afterwards for automatic selection of the name of the recipient box.

The form includes the following elements:
Entry field for the name of the source box.
Button for saving changes.

After saving the changes, the Collector checks the fact of authorization of the user on the recipient server. If the user is unauthorized, there is a jump to the new user registration form, otherwise a jump to the collection launch form.

The new user registration form allows a user of the mail system not having an account record on the recipient server to register a box for message collection.

The Collector automatically creates the name of the recipient box, using for this the name of the source box, and puts it out in a separate field. If necessary, the user can change the name of the recipient box that is proposed by the Collector.

The new user registration form includes a standard set of elements for entry of the registration data of the account record (first and last name of the user, password, confirmation of password, etc.).

After the entry and saving of the registration data, the Collector checks the possibility of registering the mail box with the data specified by the user. In the affirmative, the Collector registers the account record of the user on the recipient server and creates a mail box for it; otherwise, it asks the user to repeat the data entry.

After creating the recipient box, there is a jump to the message collection launch form.

The collection launch form makes it possible to add a source box by indicating its access parameters and to launch the message collection; it contains the following elements:
entry field for the name of the source box;
entry field for the password to access the source box;
Collector launch button.

Upon jumping to this form, the Collector automatically initializes the collection parameters: the name and port number of the source server and the recipient server, the need to remove messages from the source box after being forwarded, the frequency of checking, etc. If it was not possible to determine the collection parameters automatically, the user is asked to indicate the login, the name of the source server and the port number manually.

After pressing the launch button, the Collector saves the authorization and other collection parameters and polls the source server to check on the rights of access to the source box. If the authorization is successful, the message collection is launched. The scheduler of the Collector creates a schedule of tasks and saves this in the database of the Collector.

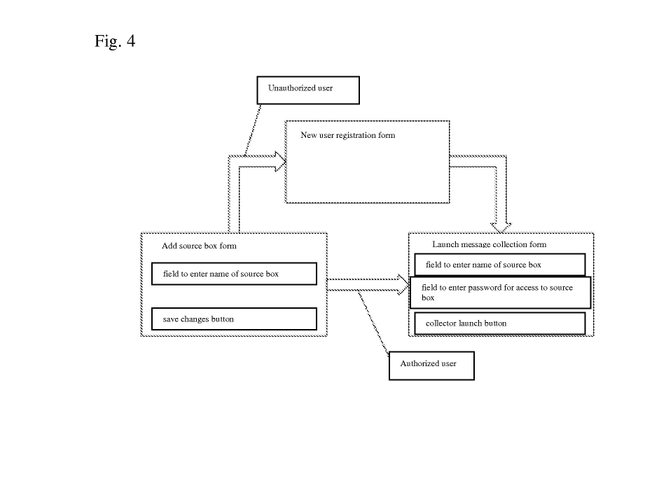

A diagram of jumps between screen forms of the external interface is illustrated in FIG. 4.

If the user who is authorized on the recipient server jumps to the internal interface, the Collector automatically determines the mail box belonging to him as the recipient box and therefore jumps at once to the message collection launch form. In this screen form, the user adds the source box, indicating the access parameters for it, and launches the message collection.

The internal interface of the Collector is accessible in the interface of the mail system of the recipient box. To call up the internal interface, a separate control element is provided in the interface of the mail system, such as a button.

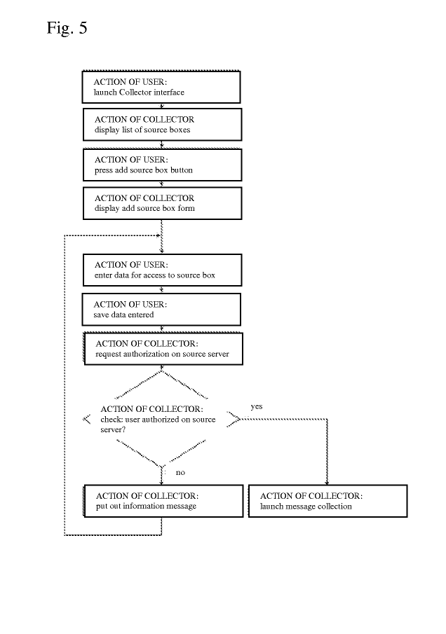

The algorithm for control of the Collector by means of the internal interface is shown in FIG. 5.

The internal interface implements an operating algorithm similar to the external interface. The difference is that, when the internal interface is launched, a screen form is displayed that contains a list of source boxes. The user can select any of the source boxes and jump to an expanded setup of the collection parameters (editing of data as to the location for the messages being forwarded, the need to save them in the recipient box after forwarding etc., removal of the source box), or specify yet another source box. In the latter case, the user presses the button for adding a source box, as a result of which the Collector displays the form for entry of access parameters to the source box.

The form contains the same interface elements as the collection launch form in the external interface, and it implements the same operating algorithm.

Integrating the Collector in a mail system makes it possible to review messages from each source box as a separate list in the interface of the mail system. As the element for control of this function, one can use, e.g., a block with names of source boxes. The address of each source box is displayed, for example, in the form of a reference that can be used to review a list of letters received from that box.

The above-presented variant of the invention is conceptual; different modifications can be realized without departing from the essence and scope of the present invention. For example, the internal or external interface can be realized not in web form, but using any other available technology; the references can be replaced by buttons; and so on.

Thus, the mail collection functionality is accessible both to authorized and unauthorized users of the mail system, including those who are not registered. A method has been developed for control of the message collection by users who do not have a mail box for message collection. The invention makes it possible to simplify the procedure for setting up the mail collection by an adaptive interface, which automatically determines the fact of authorization of the user, and also the message collection parameters, including the name of the recipient box.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. Email message collector system with ability to control the mail collection for both registered users of the mail system and for new users, containing interconnected internal and external interface means for control of the message collection, as well as a collection module for dividing up the tasks of message collection and control of the collection processor, providing for a periodic checking of specified source mail boxes and, if messages are present in them, their forwarding to a common recipient box, while the external interface is designed to designate a source box, register the recipient box if necessary, and launch the collection, being accessible both to users authorized on the recipient server and unauthorized users, and the internal interface makes possible the adding of a source box and the launching of the message collection, being part of the interface of the recipient box mail system and accessible to users authorized on the recipient server.

2. Collector system according to claim 1, in which a collection control external interface is implemented, containing screen forms with a set of elements for entry and saving of the name of the source box and the password for access to it, entry and saving of the registration parameters of the recipient box, and launching of the message collection.

3. Collector system according to claim 1, in which a collection control internal interface is implemented, containing screen forms with a set of elements for displaying a list of source boxes, entry and saving of the name of the source box and the password for access to it, launching the message collection, and controlling the display of messages in the mail system interface of the recipient box mail system, wherein the set of messages from each source box is put out as a separate list.

4. Collector system according to claim 2, in which a verification of the fact of authorization of the user on the source server is implemented in order to provide said user of the external interface with a corresponding set of screen forms.

5. Collector system according to claim 3, in the external interface of which there is implemented a recipient mail box registration form to provide access to the collection functionality to users who are not authorized on the recipient server and do not have a mail box for message collection, with possibility of automatic creation of a box name or manual designation of a name.

6. Collector system according to claim 1, whose collection module implements the option of automatic saving or deletion of messages in the source box after their forwarding to the recipient box.

7. Method of control of email message collection that is accessible to both registered users of the mail system and to new users, wherein:
the functions of control of message collection are divided up between two interfaces: external and internal, wherein access to the external interface is offered to authorized and unauthorized users, including users not having a recipient box, and access to the internal interface is offered to users who are authorized on the recipient server, it being possible for users not having a recipient box to register for one;
the fact of authorization of the user, the name of the recipient box, and specified message collection parameters from other boxes are recorded, with option of reviewing the email messages.
